(19) United States
(12) Patent Application Publication
(10) Pub. No.: US 2012/0313015 A1
(43) Pub. Date: Dec. 13, 2012

(54) IRRADIATION APPARATUS AND IRRADIATION METHOD FOR DEPOSITING A DOSE IN A TARGET VOLUME

(76) Inventor: Oliver Heid, Erlangen (DE)

(21) Appl. No.: 13/581,222

(22) PCT Filed: Feb. 2, 2011
(86) PCT No.: PCT/EP2011/051465

§ 371 Date: Aug. 24, 2012

(30) Foreign Application Priority Data
Feb. 24, 2010 (DE) 10 2010 009 010.7

(51) Int. Cl. G21K 5/04

(52) U.S. Cl. 250/492.1

(57) ABSTRACT

An irradiation apparatus for depositing a dose distribution in a target volume to be irradiated may include: an accelerator device for supplying a particle beam in order to irradiate the target volume; and a scanning device for modifying a property of the particle beam such that the particle beam is successively directed to different locations in a preset scanning volume and is thus scanned over the scanning volume during operation of the irradiation apparatus. The scanning device may be configured to: scan the scanning volume along a defined scanning path set independently of the target volume; and adjust the dose distribution to be deposited in the target volume by modulating an intensity of the particle beam when the particle beam is scanned along the scanning path. The invention further relates to an irradiation method corresponding to the irradiation apparatus.

### CROSS-REFERENCE TO RELATED APPLICATIONS

This application is a U.S. National Stage Application of International Application No. PCT/EP2011/051465 filed Feb. 2, 2011, which designates the United States of America, and claims priority to DE Patent Application No. 10 2010 009 010.7 filed Feb. 24, 2010. The contents of which are hereby incorporated by reference in their entirety.

### TECHNICAL FIELD

This disclosure relates to an irradiation apparatus and an irradiation method, by means of which a dose distribution can be deposited in a target volume with the aid of a particle beam. Such an irradiation apparatus or such an irradiation method is usually used within the scope of particle therapy in order, for example, to irradiate pathologically changed tissue.

### BACKGROUND

In the case of conventional particle therapy installations, it is possible to apply a desired dose distribution to the target volume to be irradiated by virtue of widening a particle beam and subsequently matching it to the respective shape of the target volume by superposition, for example with the aid of a collimator, and optionally through a bolus through which the particle beam passes. This application is also referred to as passive beam application.

In addition to such a beam application, which is also referred to as a passive beam application, a comparatively thin particle beam can be actively scanned over a target volume. Here, the particle beam is, in a targeted fashion, successively directed at those grid points at which a dose should be deposited in the target volume until the desired dose distribution was achieved in the target volume. The scanning is also referred to as active beam application. In the process, the target volume, which is generally delimited by curved lines, is aimed at in a targeted fashion. This means that the “write trajectory”, along which the particle beam scans over the target volume—for example by line-by-line scanning—, is matched to the specific shape of the target volume.

### SUMMARY

In one embodiment, an irradiation apparatus for depositing a dose distribution in a target volume to be irradiated comprises: an accelerator device for providing a particle beam for irradiating the target volume, a scanning device for modifying a beam property of the particle beam such that, when the irradiation apparatus is in operation, the particle beam is successively directed to different points in a predetermined scanning volume and a scan over the scanning volume is performed thus. The scanning device is embodied to scan the scanning volume along a fixed scanning path which is set independently of the target volume, and to achieve an adjustment to the dose distribution to be deposited to the target volume by virtue of modulating an intensity of the particle beam while the particle beam is scanned along the scanning path.

In a further embodiment, the scanning device is embodied to scan the scanning path with a predetermined scanning speed that is present independently of the target volume. In a further embodiment, the scanning device has at least one deflection electromagnet by means of which the particle beam can be variably deflected, wherein the deflection electromagnet is operated at a fixed deflection frequency when the irradiation apparatus is in operation. In a further embodiment, the deflection frequency is selected such that the deflection electromagnet is operated in electric resonance. In a further embodiment, the scanning device can vary the energy of the particle beam for modulating the penetration depth as per a predefined pattern. In a further embodiment, a modulation of an RF power and/or an RF phase of the accelerator device can be induced by the scanning device. In a further embodiment, the scanning device is embodied to scan the particle beam a number of times over the scanning volume.

In another embodiment, an irradiation method for depositing a dose distribution in a target volume to be irradiated may comprise the following steps: providing a particle beam and directing the particle beam onto a target volume to be irradiated, wherein at least one beam property of the particle beam is modified during the irradiation such that the particle beam is successively directed to different points in a predetermined scanning volume and a scan over the scanning volume is performed thus, wherein the particle beam is scanned over the scanning volume along a fixed scanning path which is preset independently of the target volume, and wherein a desired dose distribution to be deposited is achieved in the target volume by virtue of modulating an intensity of the particle beam while the particle beam is scanned along the scanning path.

In a further embodiment, the scanning path is scanned with a predetermined scanning speed that is independent of the target volume. In a further embodiment, the particle beam can be variably deflected by a deflection electromagnet, wherein the deflection electromagnet is operated at a fixed deflection frequency. In a further embodiment, the deflection electromagnet is operated in electric resonance. In a further embodiment, the energy of the particle beam is varied for modulating the penetration depth as per a predetermined pattern. In a further embodiment, the energy is varied by modulating an RF power and/or an RF phase of an accelerator device. In a further embodiment, the particle beam is scanned a number of times over the scanning volume.

### BRIEF DESCRIPTION OF THE DRAWINGS

Example embodiments will be explained in more detail below with reference to figures, in which:

FIG. 1 shows a schematic overview of an irradiation apparatus for irradiating a target volume, according to an example embodiment, and

FIG. 2 shows a flowchart of a method according to an example embodiment.

### DETAILED DESCRIPTION

Some embodiments provide an irradiation apparatus and an irradiation method, by means of which a desired dose distribution can be deposited in the target volume while at the same time having advantageous installation control.

For example, some embodiments provide an irradiation apparatus for depositing a dose distribution in a target volume to be irradiated, which irradiation apparatus comprises:
an accelerator device for providing a particle beam for irradiating the target volume,
a scanning device for modifying a beam property of the particle beam such that, when the irradiation apparatus is in operation, the particle beam is successively directed to different points in a predetermined scanning volume and a scan over the scanning volume is performed thus,
   wherein the scanning device is embodied
to scan the scanning volume along a fixed scanning path which is set independently of the target volume and
to achieve an adjustment to the dose distribution to be deposited to the target volume by virtue of modulating an intensity of the particle beam while the particle beam is scanned along the scanning path.

The irradiation apparatus can be used for quickly scanning a target volume using a particle beam.

Here, certain embodiments are based on the recognition that scanning using a scanning path which is matched to the target volume—as carried out by conventional installations—is connected to disadvantages. This is because a scanning path matched to the target volume means that the scanning device sets the deflection and the depth of the particle beam such that the particle beam is, as a matter of principle, only directed at grid points of the target volume.

As soon as a grid point has been sufficiently irradiated, the scanning device sets the next grid point of the target volume such that it is then irradiated. This is how the desired dose can be applied to the target volume of the conventional installations.

However, since the target volume to be irradiated usually varies in terms of its position, size and shape and is different in each individual case, the scanning device must always individually match the scanning path to the target volume. This flexibility must be reflected in the installation control, which is therefore comparatively complex for providing the option of always matching the scanning path to the individual target volume to be irradiated.

By contrast, in the irradiation apparatus disclosed herein, the scanning path is set independently of the target volume to be irradiated. By way of example, the scanning path can be stored in preset fashion in the scanning device or the control device thereof. This means that the manner of how the scanning volume is scanned is already fixed in advance and without precise knowledge of the exact geometry, i.e. the size, shape and position of the target volume.

The scanning volume can also be preset, e.g. by being stored in the control device. The scanning volume can likewise be preset independently of the target volume, i.e. here too without precise knowledge of the exact geometry thereof.

The advantage of this is that it is possible to perform the beam deflection and the depth modulation with a fixed, optimized arrangement.

This also includes the situation where a plurality of different scanning volumes can be set, e.g. with different shape, size and position, and where one of the scanning volumes is then selected. The same applies to the scanning path. Here, it is also possible for a plurality of scanning paths to be set, one scanning path of which is then selected for irradiation. However, the plurality of scanning volumes and the plurality of scanning paths are set independently of the precise geometric dimensions of the target volume, e.g. already in advance.

In one embodiment, the scanning device can be embodied to scan the scanning path with a predetermined scanning speed that is present independently of the target volume. This means that the chronological order of the scan is set independently of the target volume.

The match between the local dose deposited then and the desired intended dose distribution for the target volume is now no longer set by the geometry of the scanning process but rather by a modulation of the beam intensity by means of which the target volume is irradiated during the scanning process.

What may happen here is that, when scanning the scanning path, at certain times, the scanning device is set during the irradiation process such that the particle beam comes to rest outside of the target volume. This is the case when the target volume is smaller than the scanning volume. However, at these times, the intensity is set to zero such that there is no irradiation. The intensity is only set to values differing from zero when the scanning device is once again set such that the particle beam would once again irradiate within the target volume during the scanning of the scanning path. The scanning device is therefore set when scanning for scanning the beam path and, to be precise, independently of whether the particle beam would in the process be targeted within or outside of the target volume. The correct applied dose is achieved by intensity modulation only.

Overall, the scanning process, i.e. the scanning volume, the scanning path and/or the scanning speed, is configured independently of the target volume. This allows a significantly simplified embodiment of the control of the irradiation apparatus. The irradiation apparatus can then be optimized for the scanning path such that this one scanning path is scanned in a particularly efficient manner.

By way of example, the scanning device can have one or more deflection electromagnets by means of which the particle beam can be variably deflected in its lateral position. The deflection electromagnet can now be operated at a fixed deflection frequency when the irradiation apparatus is in operation.

The deflection electromagnet(s) can then be optimized for this fixed deflection frequency, e.g. the deflection electromagnet can be operated in electric resonance. As a result, a very quick and strong deflection can be attained without much effort.

In one embodiment, the scanning device can vary the energy of the particle beam for modulating the penetration depth as per a predefined pattern. In the case of an accelerator device which enables charged particles to be accelerated by means of an RF field, it is thus possible to control the modulation of the energy of the particle beam and thus of the penetration depth by modulating the RF power and/or RF phase. This modulation can be controlled by the scanning device.

A fixed program for controlling the energy and hence the penetration depth is particularly advantageous because a flexible control of the accelerator unit for achieving various energy levels can usually only be implemented with difficulty and in a relatively inflexible manner from a technical point of view.

As a result of the fixed scanning program, it is feasible to optimize the components of the scanning device for fast scanning. It is optionally possible to scan the whole scanning volume in a single pulse train of the accelerator, which pulse train may only take a few microseconds, e.g. less than 50 μs or less than 20 μs or 10 μs. Movement artifacts, which lead to erroneous dose distributions and are possible during the conventional, comparatively slow, target-matched scanning, are thus efficiently avoided.

In particular, the scanning device can be embodied to scan the particle beam a number of times over the scanning volume, e.g. a number of times over the scanning path. The scanning volume is overwritten a number of times in the process. As a result, it is possible to achieve a better dose distribution if the beam-intensity modulation is not sufficiently fine. However, it is also possible to accumulate a sufficiently high dose if it is only possible to deposit a dose which is too low to obtain the intended dose distribution during a once-over scanning of the scanning path.
Some embodiments provide an irradiation method for depositing a dose distribution in a target volume to be irradiated, which may comprise the following steps:
providing a particle beam and directing the particle beam onto a target volume to be irradiated,
wherein at least one beam property of the particle beam is modified during the irradiation such that the particle beam is successively directed to different points in a predetermined scanning volume and a scan over the scanning volume is performed thus,
wherein the particle beam is scanned over the scanning volume along a fixed scanning path which is preset independently of the target volume, and
wherein a desired dose distribution to be deposited is achieved in the target volume by virtue of modulating an intensity of the particle beam while the particle beam is scanned along the scanning path.

The scanning path can be scanned with a predetermined scanning speed that is independent of the target volume.

The particle beam can be variably deflected by a deflection electromagnet, wherein the deflection electromagnet is operated at a fixed deflection frequency. The deflection electromagnet can be operated in electric resonance.

The energy of the particle beam can be varied for modulating the penetration depth as per a predetermined program. The energy can be varied by modulating an RF power and/or an RF phase of an accelerator device which generates the particle beam.

The particle beam can be scanned a number of times along the scanning path.

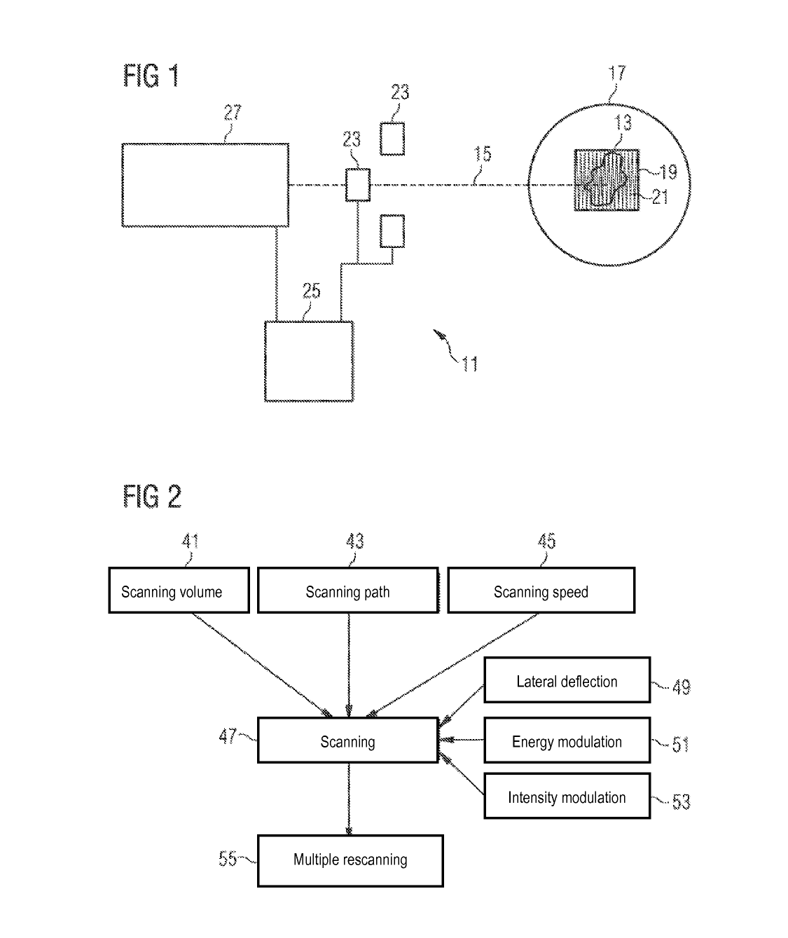

FIG. 1 shows a schematic overview of components of an irradiation apparatus 11, by means of which a target volume 13 is irradiated with the aid of a particle beam 15.

The target volume 13, to which an intended dose should be applied, is situated in an object 17. By way of example, the target volume 13 can be an irregularly shaped tumor which is situated in a patient; however, it is also possible to irradiate a phantom for research purposes or to irradiate a phantom for testing or calibration purposes.

For the purposes of irradiating the target volume 13, the particle beam 15 is directed over a scanning volume 19 which is larger than the irregularly shaped target volume 13. Here, the particle beam is directed along a scanning path 21.

Here, the scanning device of the irradiation apparatus 11 has two deflection magnet pairs 23, by means of which the particle beam 15 can be deflected perpendicular to its propagation direction in two mutually orthogonal directions. Amongst others, a control device 25 controls the deflection magnet pairs 23. The deflection is brought about as per a preset program.

Moreover, the accelerator device 27 of the irradiation apparatus 11 can be controlled by the control device 25 such that the particle beam 15 is varied in terms of its energy in accordance with a set program.

As a result of the combination of the deflection magnets 23 and the energy variation by the accelerator device 27, the particle beam 15 is directed over the scanning volume along the scanning path 21. The scanning itself, i.e. the spatial guidance of the particle beam 15, is brought about independently of the target volume 13 to be irradiated.

However, in order to ensure that the desired dose distribution is deposited in the target volume 13, the particle beam 15 is modulated in terms of the intensity while the beam is scanned along the scanning path 21. At those points at which the particle beam 15 would impinge on a region outside of the target volume 13 in the scanning volume 19, the intensity of the particle beam 15 is regulated to zero.

As soon as the particle beam 15 is directed at points within the target volume 13 by means of the scanning device, the intensity of the particle beam 15 is set to a value that differs from zero such that a dose is in actual fact deposited at these points.

Thus, the deposited dose distribution is only matched to the individual circumstances of the target volume 13 by targeted control of the intensity of the particle beam 15. The spatial properties of the scanning path 21 are selected independently of the target volume 13.

FIG. 2 shows an overview of method steps that are carried out in an example embodiment of the method.

In a first step, a scanning volume is set independently of the shape, the size and/or the position of a target volume to be irradiated (step 41).

The scanning path, onto which the scanning device of an irradiation apparatus is set, is likewise fixed such that the particle beam is guided along the scanning path. This also takes place independently of the shape, the size and/or the position of the target volume (step 43).

The scanning speed is likewise set independently of the target volume (step 45).

The particle beam is subsequently generated by the accelerator device and directed at the scanning volume. The scanning volume is scanned along the scanning path. Whenever the particle beam in the scanning volume scans over the target volume, the intensity is set to a value that differs from zero such that a dose is in actual fact deposited in the target volume (step 47).

By way of example, when scanning the particle beam, use can be made of deflection electromagnets, which are operated with a fixed deflection frequency in electric resonance in order to deflect the particle beam laterally (step 49).

The penetration depth of the particle beam can likewise be controlled by a fixed program for controlling the energy of the particle beam, by virtue of the phase or the RF power of the particle accelerator being modulated accordingly (step 51).

The dose distribution is matched to the target volume via the intensity of the particle beam, which is modulated during the scanning (step 53).

The scanning volume can be scanned a number of times until the desired dose distribution has been reached in the target volume (step 55).

### LIST OF REFERENCE SIGNS

11 Irradiation apparatus
13 Target volume
15 Particle beam
17 Object
19 Scanning volume
21 Scanning path
23 Deflection magnet
25 Control device
27 Accelerator unit
41 Step 41
43 Step 43
45 Step 45
47 Step 47
49 Step 49
51 Step 51
53 Step 53
55 Step 55

What is claimed is:

1. An irradiation apparatus for depositing a dose distribution in a target volume to be irradiated, comprising:
an accelerator device configured to provide a particle beam for irradiating the target volume,
a scanning device configured to modify a beam property of the particle beam, such that when the irradiation apparatus is in operation, the particle beam is successively directed to different points in a predetermined scanning volume and a scan over the scanning volume is thereby performed,
wherein the scanning device is configured to:
scan the scanning volume along a fixed scanning path that is preset independently of the target volume, and
achieve an adjustment to the dose distribution to be deposited to the target volume by modulating an intensity of the particle beam while the particle beam is scanned along the scanning path.

2. The irradiation apparatus of claim 1, wherein the scanning device is configured to scan the scanning path with a predetermined scanning speed that is independent of the target volume.

3. The irradiation apparatus of claim 1, wherein the scanning device has at least one deflection electromagnet configured to variably deflect the particle beam, wherein the deflection electromagnet is operated at a fixed deflection frequency when the irradiation apparatus is in operation.

4. The irradiation apparatus of claim 3, wherein the deflection frequency is selected such that the deflection electromagnet is operated in electric resonance.

5. The irradiation apparatus of claim 1, wherein the scanning device can vary the energy of the particle beam for modulating the penetration depth as per a predefined pattern.

6. The irradiation apparatus of claim 5, wherein the scanning device is configured to induce a modulation of at least one of an RF power and an RF phase of the accelerator device.

7. The irradiation apparatus of claim 1, wherein the scanning device is configured to scan the particle beam a number of times over the scanning volume.

8. An irradiation method for depositing a dose distribution in a target volume to be irradiated, comprising:
providing a particle beam, and
directing the particle beam onto a target volume to be irradiated,
wherein at least one beam property of the particle beam is modified during the irradiation such that the particle beam is successively directed to different points in a predetermined scanning volume and a scan over the scanning volume is thereby performed,
wherein the particle beam is scanned over the scanning volume along a fixed scanning path that is preset independent of the target volume, and
wherein a desired dose distribution to be deposited is achieved in the target volume by modulating an intensity of the particle beam while the particle beam is scanned along the scanning path.

9. The irradiation method of claim 8, wherein the scanning path is scanned with a predetermined scanning speed that is independent of the target volume.

10. The irradiation method of claim 8, wherein in which the particle beam is variably deflected by a deflection electromagnet operated at a fixed deflection frequency.

11. The irradiation method of claim 10, wherein the deflection electromagnet is operated in electric resonance.

12. The irradiation method of claim 8, wherein the energy of the particle beam is varied for modulating the penetration depth as per a predetermined pattern.

13. The irradiation method of claim 12, wherein the energy is varied by modulating at least one of an RF power and/or an RF phase of an accelerator device.

14. The irradiation method of claim 8, wherein the particle beam is scanned a number of times over the scanning volume.
